(19) United States
(12) Patent Application Publication
(10) Pub. No.: US 2017/0357707 A1
(43) Pub. Date: Dec. 14, 2017

(54) Hierarchical Data Collector For Use In Real Time Data Collection and Related Techniques

(71) Applicant: VidScale, Inc., Cambridge, MA (US)

(72) Inventors: Chris Gleba, Cambridge, MA (US); Bill Willcox, Cambridge, MA (US); John Scharber, Cambridge, MA (US)

(21) Appl. No.: 15/618,699

(22) Filed: Jun. 9, 2017

Related U.S. Application Data
(60) Provisional application No. 62/348,407, filed on Jun. 10, 2016.

(51) Int. Cl. G06F 17/30

(52) U.S. Cl. CPC G06F 17/30589; G06F 17/30327; G06F 17/30283; G06F 17/30339

(57) ABSTRACT

Described is a distributed real-time data collection, processing and handling system and related techniques for use in a distributed computing system having a large number of interconnected endpoints. The distributed real-time data collection, processing and handling system and techniques utilize a hierarchical data collector and method of operation.

### CROSS REFERENCE TO RELATED APPLICATIONS

This application claims priority to and benefit of U.S. Provisional Application No. 62/348,407 (filed Jun. 10, 2016), which is incorporated here by reference.

### FIELD

The concepts described herein relate generally to a method of distributed real-time data collection, processing and handling with one example application of collecting data from large systems of computing devices for the purposes of monitoring and/or control.

### BACKGROUND

Collecting data from large systems of computing devices distributed across the globe is a common task but to this day a surprisingly difficult problem to do quickly and reliably at scale. For example, a software as a service (SaaS) vendor may wish to instantly analyze the real-time state of their global infrastructure to understand the current availability, performance and cost they are providing to their clients and trigger action in their global load balancing system that reacts to the current conditions. In another example, an Internet of things (IoT) vendor may want to instantly analyze data from all their weather sensors to understand how a global weather pattern changed then trigger action in, for example, a tornado alert system. In applications such as these it is desirable to 1) collect data instantly, 2) analyze it in real-time reliably 3) and provide a result in one succinct package that can trigger an action quickly. Moreover, the solution may scale. It is beneficial if, as more computing devices, sensors, servers, and data are added, the integrity of the data and the operation of the system are not compromised. Solutions should also be low-cost.

Data collection systems on the market today often utilize approaches which fall into one of two categories: (1) a “central database” approach; and (2) a “distributed logging” approach. With reference to FIG. 1, a monitoring system 100 based up on a central database approach includes a database 102 in a central location (e.g. in New York City). Monitor 104 may comprise one or more computing devices to retrieve data from the database 102, and may be referred to as a “network operations center monitor” or “NOC monitor.” The NOC monitor 104 may access database 102 to find anomalies based on data collected in the database 102. Individual computing devices that are part system 100, and which may be located locally or remotely, may push (or pull) raw data into the database 102. In some systems, data may be either pulled from individual machines into the database or the NOC monitor 104 may pull the data into the database 102.

While a central database approach works well with relatively small systems, (e.g. monitoring hundreds of globally distributed systems), this approach suffers from several draw backs. For example, machines located in diverse regions (e.g. Asia, Europe and Africa) may be required to communicate to the central database, which may be a great distance away. If network connectivity problems arise, (e.g. due to network partitions or other connectivity issues—which become more common with distance) then these remote machines lose the ability to communicate with the central database. It can also lead to segmentation into partitions of computing devices and compromised conductivity or limited bandwidth. This phenomenon may be referred to as the “network partition problem.”

One way to alleviate part of the “network partition problem” used by some traditional systems is to install a proxy in each remote area (e.g. in data centers 106, 108, and/or 110, which may be placed in geographic regions in between the remote systems and central database). The proxy attempts to aggregate and cache the data for transmission to the central database 102. This solution may provide some amount of resilience against network partitions (data is stored by the proxy when the network is divided and retransmitted to the central database when service is restored). This caching functionality protects against data loss. However, the fundamental problem—loss of connectivity between centers 106, 108, 110, and central database 102—may still exist. If data is not available from a subset of the systems, no action can be triggered on any event from those partitioned systems. As an example, a firm has a set of machines in India serving videos to end-users in India and a “central database” monitoring system in the USA. In this example, there may be connectivity problems between India and the USA that partitions the network and prevents the “central database” monitoring system from seeing the machines in India. The India servers may serve videos to India end-users. However, if any problems arise in India (for example, one of the servers has a hardware failure) the monitoring system will not be aware of it. Normally the monitoring system may quickly trigger an action to remove such unhealthy machines from service, however if the central database is not aware of the issue, it cannot remove the unhealthy machine.

Another problem with the central database approach is “the scalability problem,” namely increasing the size and scope of the system. Since the size of an individual system is limited, if all data is being stored in one central database 102, it may be difficult to scale such a system to accommodate large distributed data sets (e.g. thousands of data points collected from hundreds of thousands of endpoints).

Still another problem is referred to as the “data set problem,” which relates to the system's ability to correlate and analyze distributed data. For example, a weather application may collect the temperature in every zip code and define an action to take when it passes a threshold (example, if it goes below freezing warn about ice). However, benefits can be achieved when the data is correlated with other data points such as dew point, pressure changes, etc. One skilled in the art may understand that as the data sets that are correlated and analyzed become larger, more system infrastructure may be required to process the data. A system that uses the central database approach may be limited in its ability to process large distributed data sets and take automated actions based on the data.

Another issue may be the “reaction time problem.” In a carrier grade network, a system availability metric of 99.999% may be required. To meet this requirement, faults must be detected and corrected quickly. One problem in such prior art monitoring systems is data is collected, correlated and analyzed then the results is presented via a display to a technician (typically called an “alert”) who must then react to correct the problem. This thus requires human involvement in the control loop of the system. The average reaction time of a technician monitoring large systems, however, is usually on the order of minutes—this means the normal reaction time to one problem can compromise 99.999% availability.

As with the network partition problem, work-arounds also exist for the reaction time problem. Referring now to FIG. 2, one work-around involves building in a scripting subsystem which consumes alerts 202, 204 created by the NOC monitor 206, 208 and performs an automated response to process the alerts 202, 204. These automated responses may be simple actions that may otherwise have been performed by a NOC technician responding to the alerts.

Alert automation interfaces with the NOC monitor 206, 208. Once the NOC monitor 206, 208 recognizes that an error has occurred, an alert may be created and then the scripting system may then, for example, remotely connect to remote system(s) to address the condition. Thus, a subset of the error conditions detected by the alerting system may be handled by alert automation rather than a NOC technician 210, 212. This works to reduce reaction time, but may be hindered by the “network partition problem.” For example, when the network partitions (i.e. fragments) due to limitations in connectivity or bandwidth, it may block the central database's access to the remote machines. In addition, this approach can require a relatively long control loop. Given that the probability for errors increases with the complexity of the system, it may be difficult to keep a long control loop like this reliable.

To combat these errors, such alert automation systems often require their own monitoring system, which can add to system complexity. Moreover, when the control loop fails, then human intervention (e.g. a NOC) is needed often, which can add latency.

Another workaround to the reaction time problem is to integrate health checks into a hardware load balancer that is close to the remote systems 214. This distributes the control loop away from a central system and the load balancer 214 can then react to local error conditions quickly. In this approach, clients 216 may access the system through load balancer 214. The load balancer 214 may perform one or more “health tests” against individual servers (e.g. servers 218, 220). If the servers 218, 220 are deemed “healthy,” e.g. without errors and able to process incoming jobs, the load balancer directs clients to the healthy server(s). If servers are spread across many disparate data centers, the suite of diverse error conditions that the load balancers must check may outstrip the load balancer's capabilities. Moreover, the use of multiple systems with differing views both diagnosing problems (i.e. both the load balancers and the NOC monitor checking for error conditions) can result in inconsistencies and complicate triage and/or recovery.

As an example of a problem that comes from such inconsistency, if a server 218, 220 has an error, NOC monitor 206, 208 could assume that the load balancer detects the condition (when in fact it did not) making it possible to miss the error condition.

In summary, distributed systems which use a monitoring system having a central database may suffer from at least four problems: (1) the “network partition problem”; (2) the “data set problem”, (3) the “scale problem”; and (4) the “reaction time problem”. Accordingly, such systems may not be suitable for use with distributed systems having many endpoints (i.e. computing devices that communicate on or across the system) to collect data from.

A second type of prior art system utilizes a method which, instead of collecting all data to a central database, stores data in text files (or other types of files) referred to as logs. With all statistics stored in a log file, the system can then be batch processed. For example, the log files may be sent to a processing system, e.g. a so-called “big data” system, such as the platform called Hadoop. The big data system may perform map-reduce processing to analyze the data and store the results in a way that scales horizontally. Then, many different clients can access these computed results. The analysis results are materialized as system alerts and NOC technicians can then see alerts and react to the underlying error conditions.

Such an approach scales well to systems with many endpoints (e.g. on the order of thousands of servers in a monitoring application) by simply adding more machines in the Hadoop cluster. While this approach solves the “scale” problem (e.g. “big data” systems such as Hadoop scale horizontally by design), it may introduce other problems.

One such problem is “the cost problem.” To queue up data analysis via this mechanism, all data must be stored in the files. Thus, the amount of data stored in log files grows quickly and in such systems, the larger the log file, the more it costs to ship, store, and analyze the data. For large or relatively complex applications, this results in a massive data files and the cost can be significant. Furthermore, the log approach still has the “reaction time problem” described above.

In view of these problems, it would be beneficial for a system to 1) collect data instantly, 2) analyze it in real-time reliably 3) and provide a result in one succinct package that can trigger an action quickly. It would be beneficial for a system to solve or alleviate (1) the “network partition problem”; (2) the “data set problem”, (3) the “scale problem”; and (4) the “reaction time problem” and (5) the “cost problem” all in one discrete system.

### SUMMARY

In an embodiment, a real-time data collection and analysis method for use in a distributed processing system having a large number of endpoints includes: a first plurality of endpoints assigned to a local-scope tier wherein each endpoint in the local-scope tier is associated with one of a plurality of separate locations. Each endpoint in the local-scope tier may include: a local-scope hierarchical data collector (HDC) arranged to collect information local to the endpoint in which the HDC exists; and consumers of processed data;

The system is N-tier meaning it may have any number of tiers, however in one embodiment the system may also include a first plurality of endpoints assigned to a global-scope tier, wherein each machine in the global-scope tier comprises: a global-scope hierarchical data collector (HDC) arranged to collect information local to the endpoint in which the HDC exists and also to collect information from any endpoint in the local-scope tier; and a global-scope consumer of the processed data.

The system may also include at least one endpoint assigned to a universal-scope tier, wherein each of the at least one endpoint in the universal-scope tier comprises: a universal-scope hierarchical data collector (HDC) arranged to collect information local to the endpoint in which the universal-scope HDC exists and also to collect information from any endpoint in the global-scope tier and any endpoint in the local-scope tier; and a universal-scope consumer of the processed data.

In another embodiment, a real-time data collection and analysis method for use in a distributed processing system having a large number of endpoints includes: assigning endpoints to one of: a local-scope tier, a global-scope tier and a universal-scope tier, wherein each endpoint in at least the local-scope tier is associated with one of a plurality of different locations; providing a hierarchical data collector (HDC) in each of the endpoints and collecting data in each endpoint via the HDC wherein each HDC at the local tier collects data concerning the endpoint in which the HDC exists and wherein each HDC at the global-scope tier collects data concerning the endpoint in which the HDC exists and collects data form one or more endpoints in the local-scope tier; providing a consumer in each of the endpoints at the local-scope tier; and providing a consumer in each of the endpoints at the global-scope tier.

### BRIEF DESCRIPTION OF THE FIGURES

FIG. 1 is a block diagram of a processing system having a central database.

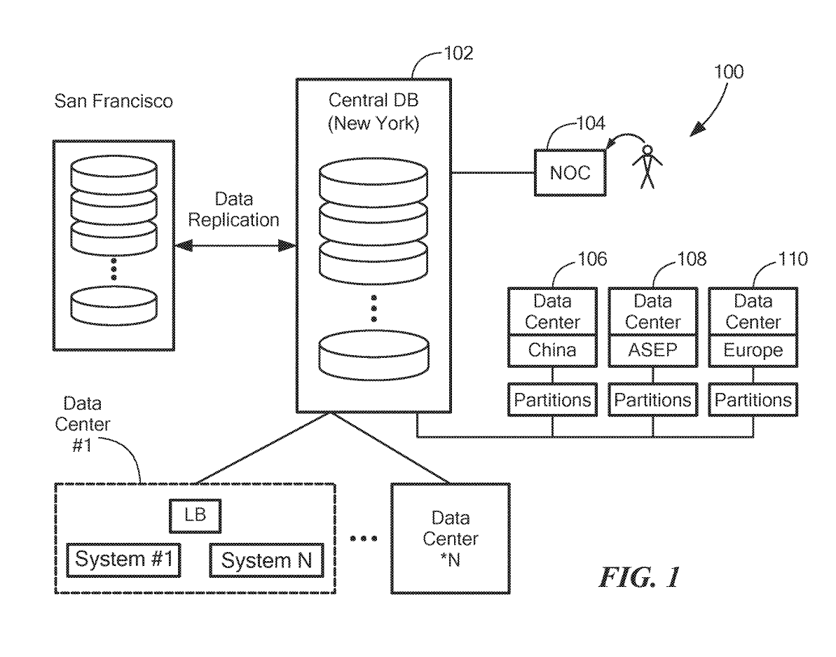

FIG. 2 is a block diagram of a processing system including processing of log files.

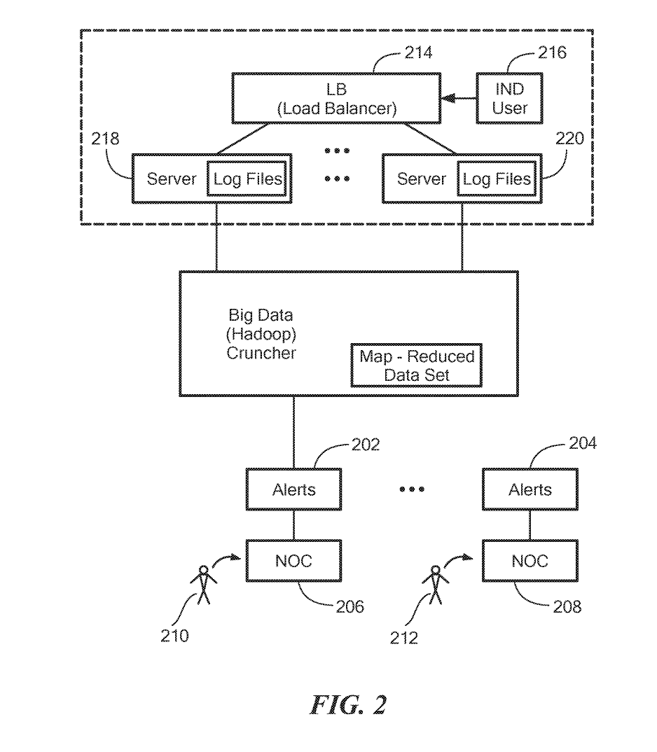

FIG. 3 is a block diagram of a hierarchical data collect (HDC) system.

FIG. 4 is a block diagram of an HDC system including local-scope, global-scope, and universal-scope tiers.

FIG. 4A is a block diagram of an HDC system including an external load balancer as a consumer.

FIG. 5 is a block diagram of a processing machine including an HDC process, data tables, and C-tables.

Like reference numbers in the drawings denote like elements.

### DETAILED DESCRIPTION

In accordance with one aspect of the concepts, systems and techniques described here, a method and system are described in which collection, transport, analysis, consumption of analyzed data and subsequent external action triggered by the data are distributed among endpoints (i.e. machines/computing devices) in a system rather than such operations being performed in separate endpoints with separate goals. By distributing the elements among all endpoints, a system having increased resiliency and scalability is provided.

Data processing system(s) described here may use a hierarchical data collection approach in which endpoints are assigned to tiers and each endpoint has an associated hierarchical data collector (HDC) and consumer (i.e. a load balancer). The HDC approach described herein may bypass the need for workarounds such as the above-mentioned “data set,” “scalability,” “reaction time,” and “cost” problem work-arounds required by “central database” and “logging systems” prior art.

In accordance with a further aspect of the concepts, systems and techniques, a system comprises a hierarchical data collector distributed among a plurality of endpoints in a distributed system, a consumer distributed among a plurality of the endpoints in the distributed system, a transport module distributed among a plurality of the endpoints in the distributed system; and a data analysis unit distributed among a plurality of the endpoints in the distributed system.

With this arrangement, a real-time data processing system for use in a large distributed system is provided. The data processing system can indicate if an endpoint in the distributed processing system is available for a resource assignment or can indicate the overall state of an endpoint or even a cluster of endpoints.

In some embodiments, the real time distributed data processing system operates autonomously for data analysis and provides consumers with views into analyzed data (e.g. monitoring devices and/or graphical user interfaces) or other consumers such a programs, scripts or other systems that that elicit action.

In embodiments, the real time distributed data processing system consumers corresponds to a view of processed data provided to a NOC technician in a system monitoring application. However, the real time distributed data processing system is not limited to providing views to a NOC. In some embodiments, the real time distributed data processing system consumer may also provide views to a customer through a website for example. The consumer of the real time distributed data processing system

In some embodiments, the system may also provide views to a service provider. Thus, a service provider may be provided information or notification when something is wrong with a particular machine or cluster for example.

As a backend, the applications to which the real time distributed data processing system may be applied are numerous.

In accordance with the concepts described herein, a hierarchical data collector (HDC) may: (1) process or analyze data as close to the endpoint as possible; (2) provide consumers with analyzed actionable data to, for example, remove human intervention from control loops, (3) maintain control loops as local to the endpoints as possible so that if there were connectivity problems in the substrate that partitions the system the islands can function autonomously and/or (4) integrates analysis and action as a consistent distributed system.

For example, if there are one or more clusters of endpoints in one location (e.g. in New York) and clusters of endpoints in a second, different location (e.g. in Tokyo), the clusters can work independently. If one fails, there may be no need to send data to a central processing site. Rather, the cluster can function autonomously to collect, transport and process data and perform action on the results. Thus, the system enables decision-making to be performed as close as possible to the endpoints to which the decision pertains.

Thus, in one embodiment in system monitoring, rather than a technician in a NOC seeing an error and taking action, the HDC removes the technician from the triage loop, bypasses the need for human intervention and triggers other subsystems as close to the endpoints as possible to resolve the problem—for example, by removing a server from DNS rotation.

In the HDC architecture, a cluster of endpoints may be referred to as a “POD”. Thus, the endpoints in NY could be considered one particular pod and the endpoints in Tokyo would correspond to another pod.

In the HDC approach, an HDC process may be running on each endpoint in each pod. At a local-scope level, the HDC is made aware of data that are available to be collected from the endpoint (for example, data from sensors, data from application(s), the network itself, the end user; potentially hundreds or thousands of different collections of data). To keep the live data set small and tractable, the HDC may use a poll-only scheme in certain embodiments. It may actively request data and then collect and store the live data it needs to accomplish a task. Furthermore, in certain embodiments, it may only request (or poll) the bare minimum amount of data required to answer a specific question or perform a task. For example, rather than pushing or polling disk statistics on a regular interval, a local HDC may only poll for disk statistics when a parent HDC or consumer asks a question about disks. This may reduce the amount of data transported in an HDC system. Not only does this reduce the load and processing required for the data, but by keeping the data set small it is tractable to correlate the data (and thus formulate complex conditional questions in real-time like “Is this POD experiencing packet loss at a rate of two standard deviations above the mean of the system?” or “What is the probability of rain at this particular moment in this particular location based upon the current sensor data?”

In some embodiments, the Structured Query Language (SQL) (an American National Standards Institute (ANSI) standard) can be used to formulate such questions. For example, a question may be: “Do you have a full disk?” Additionally, such questions can be either ad-hoc (for example, a technician enters it into an interactive interface) or programmed into the system itself to poll on a regular interval (which will be covered in more detail later in C-tables). In both cases the HDC facilitates getting the answers to these questions by traversing down the HDC endpoint hierarchy to collect the data necessary to answer the question and aggregating, reducing and analyzing it as it traverses back up the tree. For example, one simple SQL query to ask if a disk is more than 90% full on a plurality of endpoints may use the following SQL query:

SELECT ip,device,path,
blocks_free*100/blocks as pcnt_free
FROM mounts
WHERE blocks>0
HAVING pcnt_free <10;

If the response to the question “Do you have a full disk?” is ‘yes’ (i.e. if a SQL tuple is returned), then this information may be made available for consumers to poll and the consumers may take action of the information. The result of this decision may then be made available for other HDCs to poll which are “higher” in the HDC hierarchy. Such HDCs may then, in the example of system monitoring, communicate the error condition to a NOC technician, display it in a web interface for customers or be stored in another system for more analysis.

Although SQL is used as an example, the system may include a query interface that can formulate questions in other query languages. In other words, the system may include alternative or additional query interfaces or query languages that can be used to query HDCs and other machines in the HDC hierarchy.

Accordingly, in the HDC approach it is desirable to segment down to relatively small pieces of data (like in the example above, raw data about disks was analyzed down to a simple yes or no answer about whether a disk is full). This results in very small data sets to transport to HDCs higher in the hierarchy to make more complex decisions. For example, a local-scope HDC consumer such as a load balancer may remove a machine from service if the storage disks on that machine are full. The results of that local-scope HDC decision may be available for HDCs higher in the hierarchy to poll. A global-scope HDC may then see those results and notice that many machines have full storage disks so it may trigger a higher-order action such as a data purge to rectify the situation. The results of that global-scope HDC decision is available to the universal-scope HDC which may trigger an even higher order action to notify customers about the change in data, etc. In this example, the analysis is performed close to the source of the data, action is triggered as soon as there is enough data available, and analyzed data (results) are made available to higher endpoints in the hierarchy to perform more complex action.

Moreover, the underlying data behind all these decisions is still made available to poll on-demand at the top of the hierarchy in case, for example, a technician wishes to investigate details of the data underlying the decision-making.

In one embodiment, the HDC approach described herein uses SQL in real-time. The endpoints communicate with each other, recursively aggregating and analyzing results from queries down the hierarchy.

Advantages of an HDC real-time real time distributed data processing system include, but are not limited to: (1) scalability (to hundreds of thousands of endpoints with thousands of data points), (2) high availability (if partitioned into segments by substrate failure islands can function autonomously), (3) small control loop(s) close to the consumer which enables less human intervention, (4) correlation of more complex data given the analysis is distributed, (5) better consistency given it is one coordinated deterministic system, and (6) lower cost given it only transports and analyzes the bare minimum data necessary to satisfy its consumers at that moment.

The HDC technique described herein thus finds use in a wide variety of applications including, but not limited to: (1) distributed applications such as systems that underlie web or Internet applications; (2) IoT applications (any internet interfaced sensors such as, but not limited to thermostats, fire alarm, security, health aids, industrial automation, etc.); or (3) any system in which it is beneficial to collect and analyze large amounts of distributed data (e.g. all data inside house, building, country, continent, etc.) and make decisions based upon the data collected in a low cost manner in real time.

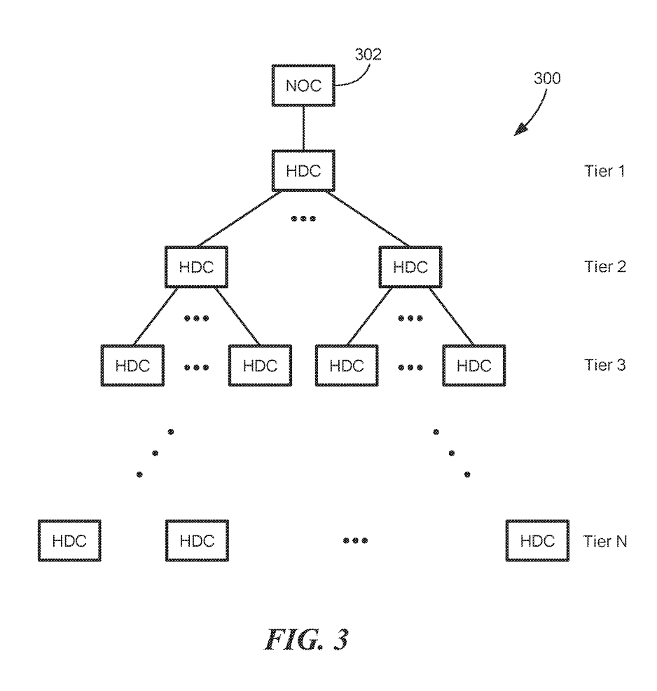

Referring now to FIG. 3, a real time distributed data processing system 300 having a hierarchical data collector (HDC) architecture includes a plurality N of tiers.

The HDC spreads data processing to endpoints located in the multiple tiers. In one embodiment, the HDC system utilizes three tiers: (1) a local-scope tier; (2) a global-scope tier; and (3) a universal-scope tier. It should thus be appreciated that, in embodiments, this approach does not use one “central database” or a “logging” batch processing approach.

As noted above, principles of the HDC approach include: (1) keeping data sets small; (2) distributing processing; (3) not having a single point of failure; (4) enabling pieces of the system to work autonomously; (5) speed and (6) low-cost. Also, it is important to analyze data as close to where it is used as possible, perform action as close as possible to where it is needed, to use only minimal data (i.e. only request data as needed) and make the results available to higher endpoints in the hierarchy to use in more and more complex analysis.

If historical information is available, it may be collected by one or more systems within or outside of the HDC process. Historical data can be quite large and thus processing historical data can be antithetical to these goals. Processing only current data by one or more embodiments of the current system therefore, increases the speed and reduces the cost of the system.

In the HDC system 300, the analysis and reaction operations may be performed by endpoints in any or all tiers of system 300. The analyzed data can be transported (e.g. communicated) between endpoints in the different tiers. The endpoints within HDC system 300 may also communicate with any consumer to perform additional action. In the application of system monitoring such consumer may be a load balancer 302 which may perform triage and remove an unhealthy system from service when necessary.

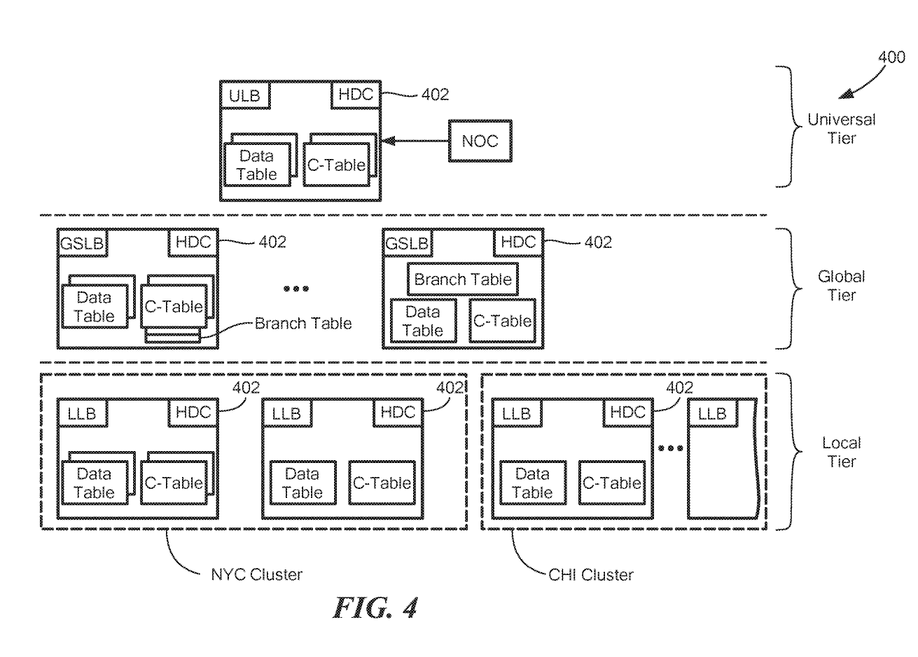

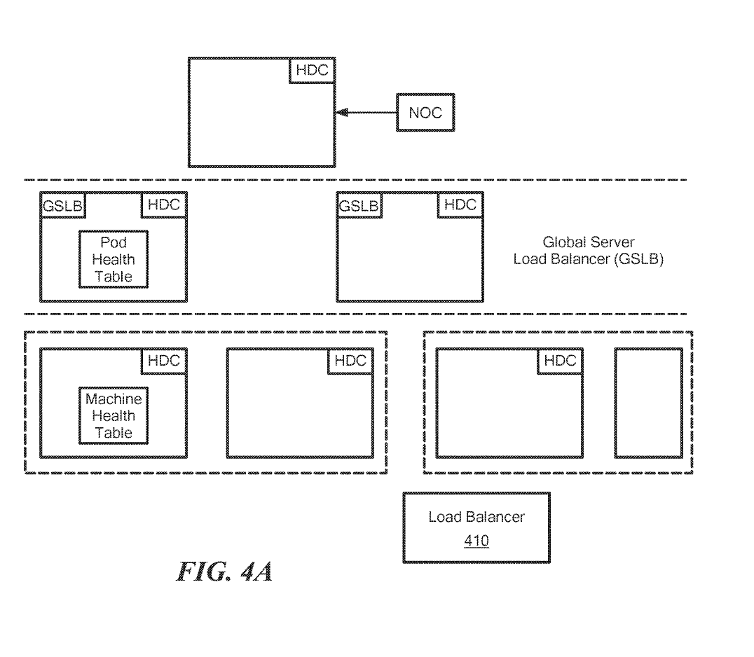

Referring now to FIG. 4, an HDC system may be implemented as an HDC process 402 executing on some or all endpoints within a computing architecture 400 capable of performing multiple functions in parallel. In one embodiment, it may be provided as a multithreaded, non-blocking process implemented in the C++ programming language and executed by one or more processors. Of course, HDC process 402 may be implemented in any programming language or by any type of software, firmware, script, etc.

The example system of FIG. 4 illustrates three levels or logical tiers which, for the purposes of this application, have been identified as: a local-scope tier; a global-scope tier and a universal-scope tier. In general overview, the endpoint at the universal-scope tier interfaces with a consumer who is interested in the most analyzed and summarized data. In the application of system monitoring the consumer may be a NOC technician however in other embodiments the consumer could be an end-user, another system, a program that performs an action, etc. Although in this illustrative embodiment, only one endpoint is shown at the universal-scope tier, in other embodiments, it may be desirable to have a plurality of endpoints at the universal-scope tier.

Each endpoint is assigned or otherwise associated with a tier. Each endpoint includes at least a hierarchical data collector (HDC). In embodiments, the endpoints at each tier include an HDC and a consumer. For example, endpoints at the local-scope tier may include a local-scope consumer. In some embodiments, the consumers may be outside of the individual endpoints. For example, a consumer such as a local load balancer may be provided outside an endpoint—e.g. at a pod level (see FIG. 4A).

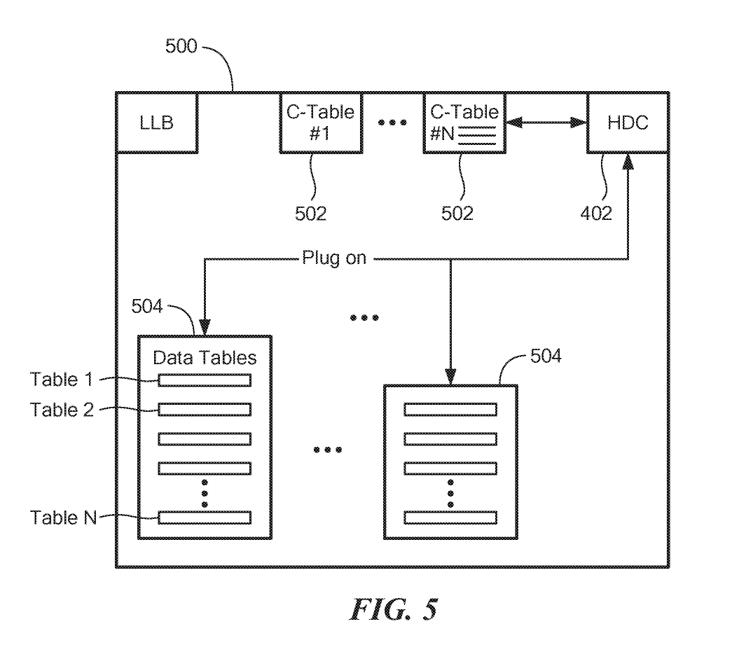

In the application of system monitoring, the global endpoints may be associated with a consumer such as a global server load balancer (GSLB). The same may be true at the universal-scope tier. Each endpoint has a plurality of different data tables available for polling—e.g. one or more Data Tables, one or more C-tables and other table types as will be described in detail further below. Suffice it here to say that in response to a query (e.g. a SQL query) the HDC retrieves only that amount of data (e.g. from Table 1, Table 2, etc. in FIG. 5) needed to answer a query. That is, a reduced, and ideally a minimal, amount of data is returned to the HDC in response to a query. Since only a reduced or minimum set of data is used to answer a question, the amount of overhead incurred in the endpoints themselves is relatively low. This approach addresses the “cost problem” since reduced or minimal processing is required. Further, since the data set being returned in response to a query is relatively small, the “scale problem” is also addressed. Further still, by utilizing small amounts of data, correlation may be performed—i.e. the system can perform more complex analysis (e.g. queries involving multiple variables).

In embodiments, endpoints make tables of data available to the HDC. There are many ways by which data is populated into the tables including, but not limited to a “Data Table” that uses a plug-in interface to subroutines called HDC collectors. In some embodiments, collectors facilitate data collection and allow the HDC to be made aware it is available in the system.

For example, when the HDC process starts on an endpoint it may initiate all collector plug-ins that are available to it; in turn, the plug-ins communicate what data they can populate for the HDC on-demand. For example, in the case of a collector that gathers information on a form of Internet routing called Border Gateway Protocol (BGP), on startup the BGP collector may instruct its local HDC to collect the following information:

| | | Human-Readable |
|---|---|---|
| Data Point Name | Data Type | Description |
| Ip | String | IPv6 address of the endpoint |
| | | that created this row |
| Prefix | String | IPv4 or IPv6 prefix learned |
| | | via BGP |
| Info | String | Additional information |
| | | about the prefix |

In embodiments, no actual BGP data is populated. Now, when a consumer asks a question such as “Show me all BGP routes” in SQL to the universal HDC (which may use the following code: “SELECT prefix FROM bgproutes;”), it may instantiate a recursion of the HDC tree where each level in the hierarchy aggregates the data at its level. For example: the universal-scope HDC asks its bgproutes collector for data then delves down the HDC hierarchy tree and requests bgproutes data from its children (global-scope HDCs), who in-turn ask their bgproutes collectors for data then delves down the HDC hierarchy tree and requests bgproutes data from its children (local-scope HDCs) who in-turn ask their bgproutes collectors for data. etc. Collectors in the hierarchy may contact their local-scope BGP routers, collate the routes, and populate the results into the bgproutes Data Table. An example of the bgproutes Data Table follows:

| Ip | Prefix | Info |
|---|---|---|
| 1.2.3.4 | 5.6.7.0/24 | NULL |
| 1.2.3.5 | 9.10.11.0/24 | NULL |
| . . . | . . . | . . . |

In embodiments, HDCs in the hierarchy ask the local BGP collector to gather the data. The HDC then populates the results into a bgproutes data table. Each HDC in the hierarchy may aggregate the results recursively back up the tree to its parent. For example, local-scope HDC may return a bgproutes table to global-scope HDCs, which aggregate their bgproutes table with the local-scope table and then pass it up to the universal-scope HDC who aggregates its bgproutes table with the global-scope table. In embodiments, the universal HDC may return BGP data from all nodes in the entire system in one succinct bgproutes table. In summary, HDC collectors can gather any data in any manner to represent it in tabular form with pre-defined data types.

The HDC at higher tiers may access data from children in lower hierarchy tiers. This so-called delve-and-aggregate functionality may be effectuated by a table called a “Branch Table”. In the bgproutes example above, a global-scope HDC may populate its bgproutes Data Table via its collectors then delve down to get bgproutes data from its children. This may be done by querying a special table named “bgproutes_branch” which executes an internal function that queries all children's bgproutes “Data Table”. It may then combine data from children endpoints via this bgproutes_branch Branch Table and combine it with its local bgproutes “Data Table.” As mentioned previously, this functionality is recursive; namely that any tier N may delve down query and aggregate data from a N+1 tier via this “Branch Table” interface.

In addition to data tables and branch tables, there may be continuous query tables (“C-tables”). Referring also to FIG. 5, each machine 500 executing an HDC process 402 may ask questions of itself (e.g. “Do I have disk errors?”) by running SQL queries against tables it has. The stateful answer to such self-questions are stored in so-called “continuous query tables” (or more simply “C-tables”) on these HDC endpoints. This self-asking of questions is one method by which HDC reduces data and makes the results available to higher HDCs in the hierarchy. Thus, the C-tables 502 may be continuously updated in response to HDC self-queries.

Accordingly, the Data Tables 504 may have stored therein (or otherwise associated therewith) data stored or otherwise available on a machine with which the HDC is associated, while the C-tables 502 have stored therein (or otherwise associated therewith) data from HDC self-queries and thus the C-tables 502 have stored therein “real-time” answers to questions or queries. It should be appreciated that entries (e.g. rows) may be only added to the C-table 502 when a specific set of conditions is met (in other words C-tables are stateful). C-tables 502 thus may be referred to as “derived” tables since the information stored in the tables is derived from information stored in other tables.

The local tier HDCs may pose a plurality of queries such as (in the application of monitoring): “Do I have disk errors?” “Do I have memory errors?” “Am I overloaded?” “Is my interface broken?” or, for example in the application of weather monitoring “Is the dew point low?”, “Is it below freezing?”, “Are wind speeds at hurricane levels?”. The results of these questions are stored in the C-table. The system may create any number of C-tables. There thus can be one or more C-tables. For example, in the application of system monitoring there may be an “Alerts C-table” where the alerts correspond to alerts raised by the machine. In the application of meteorology, a “local_weather_conditions” C-table of analyzed stateful weather metrics may exist. Any C-table required or desired at any endpoint may be created.

The system may also employ a recursion operation. For example, the recursion operation may involve continually processing data to reduce its size. In one aspect, the HDC does this by querying C-tables and then generating additional C-tables based upon the responses to the earlier C-table queries.

The C-tables may contain analyzed summary information. This will allow consumers to make very intelligent decisions in response to changing data sets. In the example of monitoring, a local load balancer may consume HDC data to remove a system from service. In an example application of meteorology, a mobile phone application may consume HDC data to alert the user of a potential severe weather condition.

Tables of any type can exist at any tier. Tables that provide similar data (the same schema) share the same name and are aggregated up the tiers when queried. They can be also combined or correlated with individual tables that exist at only one tier or one endpoint. In other words, there are no limits to the combinations, types and placement of tables. For example, in meteorology applications thousands of locally scoped HDC collectors could provide dynamic temperature data in a table called “temperatures” while a few global-scoped HDC collectors may provide static data such as the latitude and longitude of cities in a table called “cities_latlon.” When higher order questions are asked at the universal-scoped HDC tier, then data from the local “temperatures” table is aggregated in the hierarchy from local-scope, to global-scope where it is then correlated and combined with the global-scope “cities_latlon” table to provide an analysis that shows temperatures by city to the universal-scope consumer. For example, in the application of system monitoring, a global-scope HDC may also have collectors that are unique to its tier that provide information about the physical location of all machines in the system and this information may be stored in a table called “machine_locations.” For example, a global HDC collector may provide data stating that one particular machine is in Asia and another machine is in Europe and another is Australia and so on. Then a HDC consumer such as a global load balancer can ask a global scoped HDC “which machines are healthy in Asia” in response to a client request in Asia. The HDC may combine the “machine_locations” table at global scope with an aggregated “machine_health” table from the local scope to provide the load balancer with an answer. In summary, any tables of any type can be aggregated, combined, or correlated from any tier either once or recursively.

Consumers may pose questions (SQL queries) against HDC tables of any type at any tier. For example, in the application of system monitoring, a HDC consumer such as a load balancer may pose the question to a local-scope HDC: “which machine in this location can be assigned in response to a user request?” Thus, the HDC may process data to a point which allows a local load balancer to make a decision. Similarly, an HDC consumer such as a Global Server Load Balancer (GSLB) may pose the higher-order question to a global-scope HDC, such as: “Which regional collection of machines should be assigned to handle a traffic spike in Europe?” Thus, the HDC may process data to a point which allows a GSLB to make a decision. Thus, since HDC may have any number of N tiers, such questions and decision-making may be executed in N-tier.

As mentioned previously, each endpoint at any tier may include tables of any type including but not limited to C-tables and Data Tables. Furthermore, tables that are available at the differing tiers may differ. At any tier, the HDC can continuously self-query and build C-tables and pull data/answers from the C-tables to answer is own questions. Each higher scope HDC can also build additional C-tables in response to the answers it receives from lower tiers. It should be appreciated that, in certain embodiments, data collected in the local-scope tier may involve data related to that tier. At all higher tiers, such as the global-scope tier or universal-scope tier, however, it is possible for the HDCs to look at data across tiers. Furthermore, HDCs at any higher scope tier can remotely query HDCs at lower tiers and pull data to answer its own question. Since the HDC is hierarchical (see FIG. 3 and FIG. 4), it can pull data from its own tables as well as from tables which exist at lower levels of the hierarchy (e.g. data from tables of any form including Data Tables or data from other C-tables). In an embodiment, the HDCs are aware of where they fit within the hierarchy of HDCs so that they can query other HDC processes in the system. In embodiments, a setting that defines the HDC process's place in the hierarchy may be set during creation of the HDC process.

It should thus be appreciated that at each tier, different scopes of data are available depending, at least in part, upon the visibility of the LB and/or HDC processes executing on a particular endpoint. Thus, the scope of the data available at the global-scope tier may be larger than the set of the data available at the local-scope tier. Accordingly, machines at the global-scope tiers may be said to have a global vision, which may include data in machines at lower tiers, while machines at the local-scope tier have vision into data that is local unto itself.

As noted above, HDCs in any tier can ask themselves questions (i.e. can self-query) and generate C-tables. The types of questions asked at one tier of HDCs, however, may be different than the types of questions asked at another tier of HDCs. For example, in the application of system monitoring, rather than asking a local-scope HDC: “does a particular machine have disk or memory errors?”, the question may be asked as: “which pods in the hierarchy below me may be used?” at the global-scope. The answer to such a question may be stored, for example, in a global-scope C-table named “pod_availability” which would be stored in the global tier.

Thus, the global information collected may include information about the endpoints in the tier(s) below. The information collected by a global-scope HDC concerning other endpoints (e.g. endpoints at the local tier), may also be stored in tables referred to as Branch Tables. In some embodiments, Branch Tables may have stored therein information from endpoints at all tiers above the local-scope tier.

It should be appreciated that HDC tables at any higher tier may recursively aggregate data at its own tier (e.g. Data Tables, C-tables, etc.) as well as tables from tiers below it via the Branch Table mechanism.

Referring briefly to FIG. 4A, a consumer such as a load balancer may be provided locally within each machine. In some embodiments, a load balancer consumer 410 may be provided outside of an individual machine. For example, in some embodiments, a consumer in the form of a local load balancer may be provided within each cluster. In other embodiments, however, the local load balancer could be outside each cluster. The load balancer can make specific decisions about whether a machine can satisfy the requirements of specific task, i.e. whether a machine can accept specific processing jobs (e.g. processing jobs assigned by the load balancer. Thus, if load balancer 410 sees one resource is somewhat broken, another resource is very broken, and another resource is healthy, load balancer 410 may assign processing jobs to the healthy resource rather than to one of the broken resources. The local load balancer can make decisions on its own autonomously without human intervention. Failure conditions may automatically remove a resource from the system. In one embodiment, each cluster may be provided having its own load balancer and each load balancer communicates with the others.

Referring again to FIG. 4, it should also be understood that the HDC can utilize the C-tables to generate additional questions. For example, in the application of system monitoring, if an endpoint includes an Alerts C-table and a Health C-table, the HDC can create additional questions using the data stored in the C-tables.

At the highest level (i.e. the so-called universal-scope tier in an illustrative embodiment of FIG. 4), the HDC operates in a manner similar to the HDCs in the tiers below. At the universal tier, the HDC may reside in a Network Operations Center (NOC) or any number of data centers and may itself be distributed. In an embodiment, the HDC at the universal-scope tier only knows the nodes below it.

It should be appreciated that the HDC technique can be used for any number of different data sets that are distributed in nature. The HDC approach can be used, for example, in IoT applications (e.g. monitor home sensors, monitor sensors in factories in real time manufacturing processes, etc.). For example, HDC can be applied to collect data from a system of sensors in a home, analyze it then store the results in the cloud via a consumer. Another HDC system may collect and analyze the real-time temperature data and determine if the temperature is higher than a predetermined temperature. If so, a consumer may trigger a command to turn on an air conditioning in the home.

It should be appreciated that such requests may be poll-based. So when a poll comes in and poses a question to an HDC, the HDC pulls data and provides an amount of time for which the data is valid. The machine then appropriately processes the data within the allotted time. Thus, there is no inherent latency. In one example embodiment, the goal of the system is to detect issues in 30 seconds or less.

It should be appreciated that described herein is processing performed by a processing apparatus which may, for example, be provided as part of a processing system such as that shown in FIG. 4. Some of the processing can be carried out via an empirical procedure or a database while others can be carried out utilizing computer software instructions or groups of instructions executing on a processor. Thus, some of the processes described herein may be implemented via computer software executed by a computer processor, while others may be implemented in a different manner e.g. via an empirical procedure.

Alternatively, some of the processing can be performed by functionally equivalent circuits such as a digital signal processor (DSP) circuit or an application specific integrated circuit (ASIC). The process described herein does not depict the syntax of any particular programming language. Rather, the processing herein described illustrate the functional information one of ordinary skill in the art requires to perform the processes or to fabricate circuits or to generate computer software to perform the processing required of the particular apparatus. It should be noted that where computer software can be used, many routine program elements, such as initialization of loops and variables and the use of temporary variables are not shown. It will be appreciated by those of ordinary skill in the art that unless otherwise indicated herein, the particular sequence of processes described is illustrative only and can be varied without departing from the spirit of the invention.

The systems and methods described herein may be implemented hardware, software, or a combination. Software may comprise software instructions stored on one or more computer readable medium which, when executed by one or more processors, cause the processors to perform operations that implement the systems and methods.

Having described preferred embodiments of the invention it will now become apparent to those of ordinary skill in the art that other embodiments incorporating these concepts may be used. Accordingly, the invention should not be limited to the described embodiments but rather should be limited only by the spirit and scope of the following claims.

1. A distributed real-time data collection, processing and handling system for use in a distributed system having a large number of endpoints, comprising of:
a first plurality of endpoints assigned to a local-scope tier wherein each endpoint in the local-scope tier is associated with one of a plurality of different locations wherein each endpoint in the local-scope tier comprises:
a local-scope hierarchical data collector (HDC) arranged to collect information local to the endpoint in which the HDC exists; and
a local consumer of the processed data that is capable of performing action
a first plurality of endpoints assigned to a global-scope tier, wherein each endpoint in the global-scope tier comprises:
a global-scope hierarchical data collector (HDC) arranged to collect information local to the endpoint in which the HDC exists and also to collect information from any endpoint below it in the local-scope tier; and
a global-scoped consumer of the processed data; and
at least one endpoint assigned to a universal-scope tier, wherein each of the at least one endpoint in the universal-scope tier comprises:
a universal-scope hierarchical data collector (HDC) arranged to collect information local to the endpoint in which the universal-scope HDC exists and also to collect information from any endpoint in the global-scope tier and any endpoint in the local-scope tier; and a universal-scope consumer of processed data.

2. The distributed real-time data collection, processing and handling system of claim 1 wherein each endpoint in the local-scope tier comprises a local-scope consumer of the processed data.

3. The distributed real-time data collection, processing and handling system of claim 1 wherein each endpoint in the global-scope tier comprises a global-scope consumer of the processed data.

4. The distributed real-time data collection, processing and handling system of claim 1 wherein each endpoint in the local-scope, global-scope and universal-scope tiers includes at least one data table.

5. The distributed real-time data collection, processing and handling system of claim 1 wherein each local-scope HDC, global-scope HDC and universal-scope HDC comprises means for generating C-tables.

6. The distributed real-time data collection, processing and handling system of system of claim 5 wherein each endpoint in the local-scope tier, global-scope tier and universal-scope tier includes at least one of:
at least one data table having information stored therein; and
at least C-table having stored therein information derived from information stored in at least one other table.

7. The distributed real-time data collection, processing and handling system of claim 5 wherein each endpoint in the global-scope and universal-scope tiers includes at least one Branch Table.

8. A distributed real-time data collection, processing and handling method for use in a distributed processing system having a large number of endpoints, the processing method comprising:
assigning endpoints to one of: a local-scope tier, a global-scope tier and a universal-scope tier, wherein each endpoint in at least the local tier is associated with one of a plurality of different locations;
providing a hierarchical data collector (HDC) in each of the endpoints and collecting data in each endpoint via the HDC wherein each HDC at the local-scope tier collects data concerning the endpoint in which the HDC exists and wherein each HDC at the global-scope tier collects data concerning the endpoint in which the HDC exists and collects data form one or more endpoints in the local-scope tier;
providing a local-scope consumer of processed data in each of the endpoints at the local tier; and
providing a global-scope consumer of processed data in each of the endpoints at the global-scope tier.

9. The distributed real-time data collection, processing and handling method of claim 8 further comprising:
autonomously performing action on external entities based upon information stored on one or more tables stored in one or more endpoints at one or more of the local-scope, global-scope and universal-scope tiers.

10. The distributed real-time data collection, processing and handling method of claim 9 further comprising transporting data between at least two of: HDC systems at the local-scope tier; HDC systems at the global-scope; and an HDC system at the universal-scope tier.

11. The distributed real-time data collection, processing and handling method of claim 10 further comprising performing data analysis operations among all the endpoints in each of the local-scope, global-scope and universal-scope tiers such that data analysis operations are distributed among all endpoints in all tiers.

12. The distributed real-time data collection, processing and handling method of claim 10 further comprising of consumers of processed data for the purposes of performing action on external entities.

13. The distributed real-time data collection, processing and handling method of claim 10 further comprising a consumer performing action on external entities at each of the local-scope, global-scope and universal-scope tiers such that actions on external entities are distributed among any endpoints at all tiers.

14. The distributed real-time data collection, processing and handling method of claim 8 further comprising using the method in an internet of things (IoT) application as well as software as a service (SaaS) application.

15. The distributed real-time data collection, processing and handling method of claim 13 further comprising using the method to collect, analyze and perform action based on data from sensors in factories in a real-time manufacturing process.
